(19) United States
(12) Patent Application Publication
(10) Pub. No.: US 2015/0120434 A1
(43) Pub. Date: Apr. 30, 2015

(54) Flexible Experiment Framework for Hierarchical Data

(71) Applicant: GOOGLE INC., MOUNTAIN VIEW, CA (US)

(72) Inventors: Vidya Iyer, Cupertino, CA (US); John Fitzpatrick, Los Gatos, CA (US); Dan Halem, San Jose, CA (US); Neil Inala, San Jose, CA (US); Brian C. Bengnoche, Reston, VA (US); Fredrick J. Faber, East Greenwich, RI (US); James Jones, Pleasanton, CA (US)

(73) Assignee: GOOGLE INC., MOUNTAIN VIEW, CA (US)

(21) Appl. No.: 14/067,546

(22) Filed: Oct. 30, 2013

(51) Int. Cl. G06Q 30/02

(52) U.S. Cl. CPC G06Q 30/0243; G06Q 30/0246
USPC 705/14.42

(57) ABSTRACT

Methods, systems, and apparatus include computer programs encoded on a computer-readable storage medium for conducting an experiment for a campaign. A method includes: identifying a campaign including one or more content items and current selection criteria; receiving an indication of a proposed modification to be made to the campaign; storing the proposed modification as a draft campaign including the proposed modification in a first structure that includes the differences that are proposed to the campaign and a second structure that represents the campaign with the proposed modifications applied; determining a split to be applied as between using current campaign parameters or current selection criteria for a first portion of received traffic and using the proposed modification in the draft campaign for a second portion of the received traffic; and conducting an experiment based on using received traffic and in accordance with the split.

### BACKGROUND

This specification relates to information presentation.

The Internet provides access to a wide variety of resources. For example, video and/or audio files, as well as web pages for particular subjects or particular news articles, are accessible over the Internet. Access to these resources presents opportunities for other content (e.g., advertisements) to be provided with the resources. For example, a web page can include slots in which content can be presented. These slots can be defined in the web page or defined for presentation with a web page, for example, along with search results.

A content sponsor may have one or several goals related to the presentation of their content. However, the content sponsor may not be able to accurately predict performance for a number of reasons. Experiments can be run, for example, varying aspects associated with the selection criteria used to select a given content item of a content sponsor. Such experiments may or may not produce a reasonable expectation of meeting the one or several goals.

### SUMMARY

In general, one innovative aspect of the subject matter described in this specification can be implemented in methods that include a method for conducting an experiment for a campaign. A method includes: identifying a campaign, the campaign including one or more groups of content items and current selection criteria for each group, wherein the current selection criteria define conditions that are to be satisfied for an individual content item to be eligible to be presented responsive to a received request; receiving an indication of a proposed modification to be made to one or more current campaign parameters or the current selection criteria associated with a group; storing the proposed modification as a draft campaign including storing the proposed modification in a first structure that includes only the differences that are proposed to the campaign and a second structure that represents the campaign with the proposed modifications applied; determining a split to be applied as between using the current campaign parameters or current selection criteria for a first portion of received traffic and using the proposed modification in the draft campaign for a second portion of the received traffic; and conducting an experiment based on using received traffic and in accordance with the split including delivering impressions based on both the current campaign parameters or current selection criteria and the proposed modification including serving content in accordance with the campaign and the draft campaign.

In general, another aspect of the subject matter described in this specification can be implemented in computer program products. A computer program product is tangibly embodied in a computer-readable storage device and comprises instructions. The instructions, when executed by a processor, cause the processor to: identify a campaign, the campaign including one or more groups of content items and current selection criteria for each group, wherein the current selection criteria define conditions that are to be satisfied for an individual content item to be eligible to be presented responsive to a received request; receive an indication of a proposed modification to be made to one or more current campaign parameters or the current selection criteria associated with a group; store the proposed modification as a draft campaign including storing the proposed modification in a first structure that includes only the differences that are proposed to the campaign and a second structure that represents the campaign with the proposed modifications applied; determine a split to be applied as between using the current campaign parameters or current selection criteria for a first portion of received traffic and using the proposed modification in the draft campaign for a second portion of the received traffic; and conduct an experiment based on using received traffic and in accordance with the split including delivering impressions based on both the current campaign parameters or current selection criteria and the proposed modification including serving content in accordance with the campaign and the draft campaign.

In general, another aspect of the subject matter described in this specification can be implemented in systems. A system includes one or more processors and one or more memory elements. The memory elements include instructions that when executed cause the one or more processors to: identify a campaign, the campaign including one or more groups of content items and current selection criteria for each group, wherein the current selection criteria define conditions that are to be satisfied for an individual content item to be eligible to be presented responsive to a received request; receive an indication of a proposed modification to be made to one or more current campaign parameters or the current selection criteria associated with a group; store the proposed modification as a draft campaign including storing the proposed modification in a first structure that includes only the differences that are proposed to the campaign and a second structure that represents the campaign with the proposed modifications applied; determine a split to be applied as between using the current campaign parameters or current selection criteria for a first portion of received traffic and using the proposed modification in the draft campaign for a second portion of the received traffic; and conduct an experiment based on using received traffic and in accordance with the split including delivering impressions based on both the current campaign parameters or current selection criteria and the proposed modification including serving content in accordance with the campaign and the draft campaign.

These and other implementations can each optionally include one or more of the following features. Receiving an indication of a proposed modification can include receiving an indication of a group for inclusion in an experiment including identifying a current set of selection criteria associated with the group and receiving an indication of a proposed modification to be made to the current set of selection criteria associated with the group. The split can be at a geographic, device or cookie level. The proposed modification can be at a campaign level including modifications of one or more of geographic selection parameters, bidding parameters, extensions, or scheduling parameters. A user interface can be provided that includes a list of experiments, predictions and results. The campaign can be a first campaign. The first campaign can be synchronized with a different, second campaign based on results of the experiment including applying the proposed modifications to the second, different campaign. Conducting the experiment can include measuring statistical significance of the proposed modification and providing a report of the same to a campaign sponsor. A determination can be made regarding when the experiment has run long enough to be statistically significant and a campaign sponsor can be Potential proposed modifications for the campaign can be automatically selected without interaction of a campaign sponsor, automatic experiments can be conducted, and suggestions can be provided to the campaign sponsor based on the automatic experiments. An indication to adopt the proposed modification can be received and the campaign can be converted based on the draft campaign including recalling the draft campaign and updating one or more selection criteria associated with the campaign based on the draft campaign. Multiple experiments can be conducted including creating a draft campaign for each experiment, reporting experiment results and converting one or more of the draft campaigns based on results of a respective experiment. An experiment can be re-ran using a historical data log of transactions to simulate results of the experiment as against previous traffic and the results can be used to predict a success rate for the experiment. The proposed modification can indicate a first change to a first campaign parameter and a second change to a second campaign parameter and receiving the indication to adopt the proposed modification can include receiving an indication to adopt the first change but not the second change. A modification to the campaign can be received after storing the draft campaign that modifies different campaign parameters or selection criteria than the proposed modification. The modification can be applied to the campaign and to the draft campaign.

Particular implementations may realize none, one or more of the following advantages. A content sponsor can preview changes to a campaign before such changes are put into production. A content sponsor can view data which indicates an effect changes may have on a campaign, before such changes are put into production. A content sponsor can incorporate an experiment into a base campaign or can create a new campaign separate from the base campaign based on the experiment.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment for conducting an experiment for a campaign.

FIG. 2 illustrates an example user interface that shows changes between a base campaign and an experiment.

FIG. 3 illustrates an example user interface.

FIG. 4 is a block diagram of an example system for conducting an experiment for a campaign.

FIG. 5 is a flowchart of an example process for conducting an experiment for a campaign.

FIG. 6 is a block diagram of computing devices that may be used to implement the systems and methods described in this document, as either a client or as a server or plurality of servers.

Like reference numbers and designations in the various drawings indicate like elements.

### DETAILED DESCRIPTION

A campaign sponsor, an administrator of a campaign, or an automated process can provide an indication of a proposed modification to be made to one or more campaign parameters of a content campaign. The content campaign can include, for example, one or more groups of content items and selection criteria for each group. The proposed modification can be a modification to be made to one or more campaign parameters or the selection criteria associated with a group. In response to the provided indication of the proposed modification, a split to be applied can be determined, wherein the split can be between using campaign parameters or original selection criteria and the proposed modification against received traffic. In some implementations, the proposed modification can be stored as a draft campaign. For example, the proposed modification can be stored in a first structure that includes only the differences that are proposed to the campaign and in a second structure that represents the campaign with the proposed modifications applied. An experiment can be conducted based on using received traffic and in accordance with the split including delivering impressions based on both the campaign parameters or original selection criteria and the proposed modification including serving content in accordance with the campaign and the draft campaign.

For situations in which the systems discussed here collect information about users, or may make use of information about users, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be manipulated in one or more ways before it is stored or used, so that certain information about the user is removed. For example, a user's identity may be manipulated so that no identifying information can be determined for the user, or a user's geographic location may be generalized where location information is obtained (such as to a city, ZIP code, or state level), so that a particular location of a user cannot be determined. Thus, the user may have control over how information about the user is collected and used by a content server.

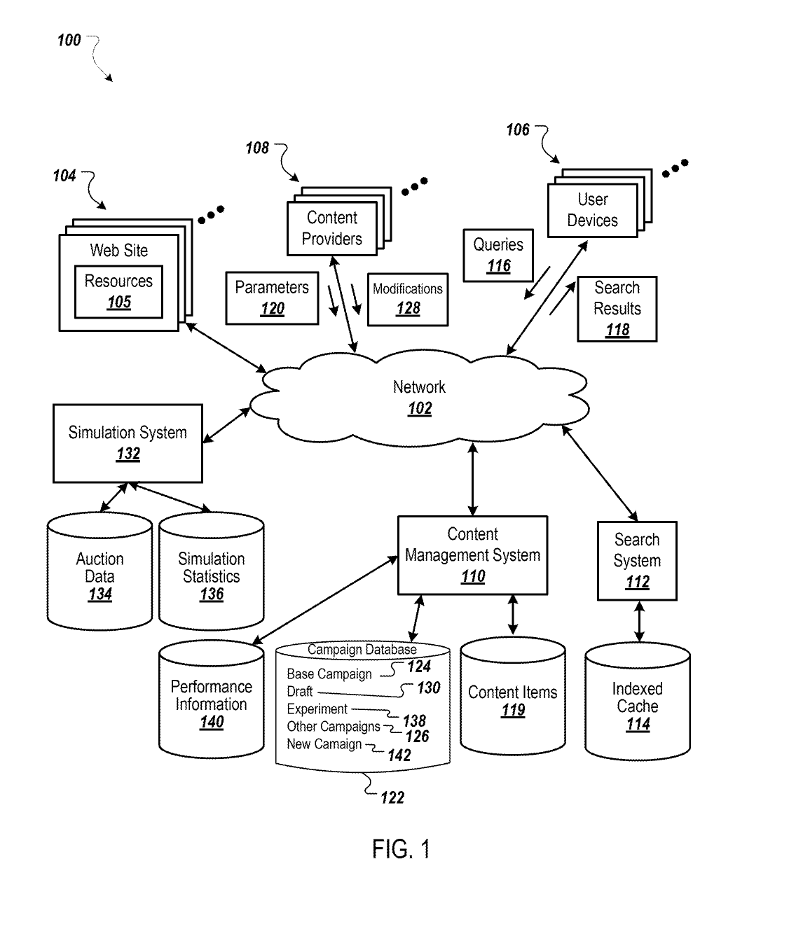

FIG. 1 is a block diagram of an example environment 100 for providing content to a user. The example environment 100 includes a network 102, such as a local area network (LAN), a wide area network (WAN), the Internet, or a combination thereof. The network 102 connects websites 104, user devices 106, content providers 108, publishers, and a content management system 110. The example environment 100 may include many thousands of websites 104, user devices 106, and content providers 108. The content management system 110 may be used for selecting and providing content in response to requests for content. The content providers 108 can be, for example, advertisers. Other types of content providers are possible.

A website 104 includes one or more resources 105 associated with a domain name and hosted by one or more servers. An example website 104 is a collection of web pages formatted in hypertext markup language (HTML) that can contain text, images, multimedia content, and programming elements, such as scripts. Each website 104 can be maintained by a content publisher, which is an entity that controls, manages and/or owns the website 104.

A resource 105 can be any data that can be provided over the network 102. A resource 105 can be identified by a resource address that is associated with the resource 105. Resources 105 include HTML pages, word processing documents, portable document format (PDF) documents, images, video, and news feed sources, to name only a few. The resources 105 can include content, such as words, phrases, videos, images and sounds, that may include embedded information (such as meta-information hyperlinks) and/or embedded instructions (such as scripts).

A user device 106 is an electronic device that is under control of a user and is capable of requesting and receiving resources 105 over the network 102. Example user devices 106 include personal computers, tablet computers, mobile communication devices (e.g., smartphones), televisions, set top boxes, personal digital assistants and other devices that can send and receive data over the network 102. A user device 106 typically includes one or more user applications, such as a web browser, to facilitate the sending and receiving of data over the network 102. The web browser can interact with various types of web applications, such as a game, a map application, or an e-mail application, to name a few examples.

A user device 106 can request resources 105 from a website 104. In turn, data representing the resource 105 can be provided to the user device 106 for presentation by the user device 106. User devices 106 can also submit search queries 116 to the search system 112 over the network 102. In response to a search query 116, the search system 112 can, for example, access the indexed cache 114 to identify resources 105 that are relevant to the search query 116. The search system 112 identifies the resources 105 in the form of search results 118 and returns the search results 118 to the user devices 106 in search results pages. A search result 118 is data generated by the search system 112 that identifies a resource 105 that is responsive to a particular search query 116, and includes a link to the resource 105. An example search result 118 can include a web page title, a snippet of text or a portion of an image extracted from the web page, and the URL (Unified Resource Location) of the web page.

The data representing the resource 105 or the search results 118 can also include data specifying a portion of the resource 105 or search results 118 or a portion of a user display (e.g., a presentation location of a pop-up window or in a slot of a web page) in which other content (e.g., advertisements) can be presented. These specified portions of the resource or user display are referred to as slots or impressions. An example slot is an advertisement slot.

When a resource 105 or search results 118 are requested by a user device 106, the content management system 110 may receive a request for content to be provided with the resource 105 or search results 118. The request for content can include characteristics of one or more slots or impressions that are defined for the requested resource 105 or search results 118. For example, a reference (e.g., URL) to the resource 105 or search results 118 for which the slot is defined, a size of the slot, and/or media types that are available for presentation in the slot can be provided to the content management system 110. Similarly, keywords associated with a requested resource or a search query 116 for which search results 118 are requested can also be provided to the content management system 110 to facilitate identification of content that is relevant to the resource or search query 116.

Based, for example, on data included in the request for content, the content management system 110 can select (e.g., from a content items data store 119) content items that are eligible to be provided in response to the request, such as content items having characteristics matching the characteristics of a given slot. As another example, content items having selection criteria (e.g., keywords) that match the resource keywords or the search query 116 may be selected as eligible content items by the content management system 110. One or more selected content items can be provided to the user device 106 in association with providing an associated resource 105 or search results 118.

In some implementations, the content management system 110 can select content items based at least in part on results of an auction. For example, content providers 108 can provide bids specifying amounts that the content providers 108 are respectively willing to pay for presentation of their content items. In turn, an auction can be performed and the slots can be allocated to content providers 108 according, among other things, to their bids and/or the relevance of a content item to content presented on a page hosting the slot or a request that is received for the content item. For example, when a slot is being allocated in an auction, the slot can be allocated to the content provider 108 that provided the highest bid or a highest auction score (e.g., a score that is computed as a function of a bid and/or a quality measure). When multiple slots are allocated in a single auction, the slots can be allocated to a set of bidders that provided the highest bids or have the highest auction scores.

A content provider 108 or content sponsor can create a content campaign associated with one or more content items using tools provided by the content management system 110. For example, the content management system 110 can provide one or more account management user interfaces for creating and managing content campaigns. The account management user interfaces can be made available to the content provider 108, for example, either through an online interface provided by the content management system 110 or as an account management software application installed and executed locally at a content provider's client device.

A content provider 108 can, using the account management user interfaces, provide campaign parameters 120 which define a content campaign. The content campaign can be created and activated for the content provider 108 according to the parameters 120 specified by the content provider 108. Campaign parameters 120 can include, for example, a campaign name, a preferred content network for placing content, a budget for the campaign, start and end dates for the campaign, a schedule for content placements, content (e.g., creatives), bids, and selection criteria. Selection criteria can include, for example, a language, one or more geographical locations or websites, and/or one or more selection terms. The campaign parameters 120 can be stored in a campaign database 122, such as in association with a base campaign 124 or in association with one or more other campaigns 126.

A content provider 108 may desire to preview changes to a campaign before such changes are put into production. For example, the content provider 108 may desire to understand the nature and value of changes that may be made to a campaign, such as to view data which indicates whether a change is beneficial to the content provider 108. For instance, one or more proposed modifications 128 to the base campaign 124 can be received from the content provider 108. As another example, one or more proposed modifications can be suggested by the content management system 110. The proposed modifications 128 can be, for example, modifications to one or more campaign parameters 120, such as selection criteria. The proposed modifications 128 can include, for example, the addition or removal of keywords, the changing of bids, and/or the changing of content (e.g., text) of a content item. Other modifications are possible.

In some implementations, the content provider 108 specifies the proposed modifications 128 using a draft editor, with the proposed modifications 128 provided by the content provider 108 using the draft editor being used to define a draft campaign. For example, a draft campaign 130 can be stored in the campaign database 122. The draft campaign 130 can be stored using a same schema as used for the base campaign 124 and the other campaigns 126. Schemas are discussed in greater detail below.

An effect of applying the proposed modifications 128 to the base campaign 124 can be measured by performing a simulation that includes re-running previous auctions. For example, a simulation system 132 can access historical auction data 134 (e.g., auction data from the previous week) and re-run the auctions associated with the accessed auction data 134 with the draft campaign 130 participating in the auctions. The simulation system 132 can determine, and the content provider 108 can view, simulation statistics 136, such as impressions, clicks, click-through rate, and cost. The simulation can be a way for the content provider 108 to prospectively predict the value of implementing the proposed modifications 128.

A more accurate measurement of an effect of applying the proposed modifications 128 can be determined by running an experiment using live traffic. For example, an experiment 138 can be generated from the draft campaign 130 and stored in the campaign database 122. The content management system 110 can determine a split as to using the experiment 138 or the base campaign 124 for received requests. For example, for a certain percentage (e.g., twenty percent) of received requests for content, the content management system 110 can include the experiment 138 in an auction associated with the request for content in place of the base campaign 130. The content management system 110 can determine performance information 140 for both the base campaign 124 and the experiment 138 during the experiment. The content provider 108 can view a comparison between performance information for the base campaign 124 and the experiment 138.

Based on viewing the comparison of performance information between the base campaign 124 and the experiment 138 and/or on viewing the simulation statistics 136, the content provider 108 may decide to implement the proposed modifications 128. For example, the proposed modifications 128 can be incorporated into the base campaign 130. As another example, the proposed modifications 128 can be included in a new campaign 142, with the new campaign 142 being a separate campaign from the base campaign 124.

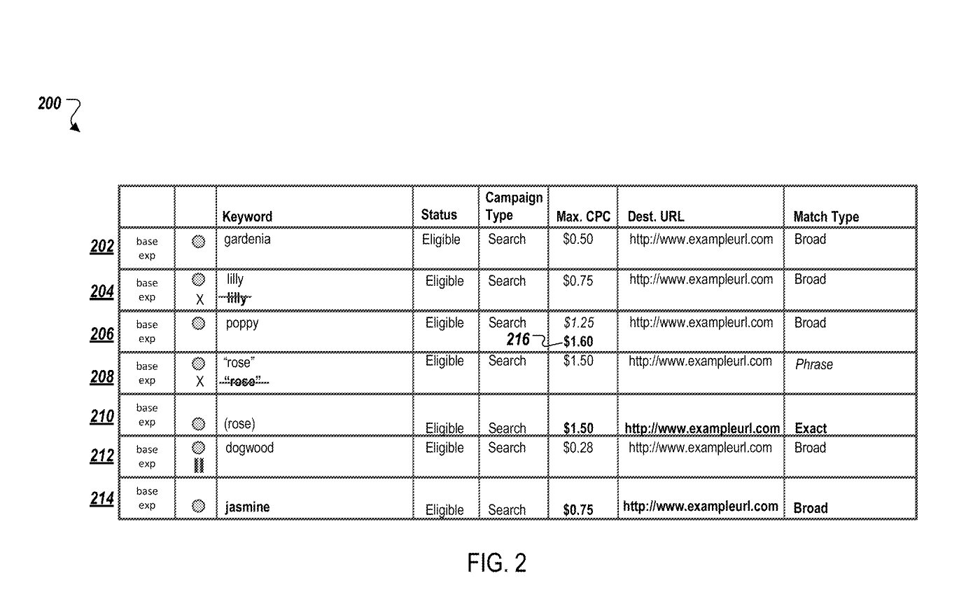

FIG. 2 illustrates an example user interface 200 that shows changes between a base campaign and an experiment. A similar user interface can be used to show changes between a draft and a base campaign. The user interface 200 includes rows 202-214, with each row 202-214 corresponding to a keyword that is included in the base campaign and/or in the experiment. In rows 202-214, a circle symbol next to a “base” indicator indicates that a respective keyword is included in the base campaign. For example, as respectively illustrated by rows 202, 204, 206, 208, and 212, keywords of “gardenia”, “lily”, “poppy”, “rose”, and “dogwood” are included in the base campaign. The keyword “lily” is deleted in the experiment, as illustrated by an “X” symbol and the crossed-out lily keyword (e.g., lily) next to an “exp” indicator in row 204. A bid for the “poppy” keyword is increased in the experiment from $1.25 to $1.60, as indicated by a bid 216 included in row 206. A keyword of “jasmine” is added to the experiment, as illustrated by row 214. The “dogwood” keyword is paused in the experiment, as indicated by a pause symbol next to the “exp” indicator in row 212.

The match type for the “rose” keyword is changed in the experiment from phrase to exact. In some implementations, the changing of a match type can be implemented by the deletion in the experiment of the keyword with the old match type and the addition to the experiment of the keyword with the new match type. For example, row 208 represents the deletion in the experiment of the “rose” keyword with the phrase match type and row 210 represents the addition in the experiment of the “rose” keyword with the exact match type.

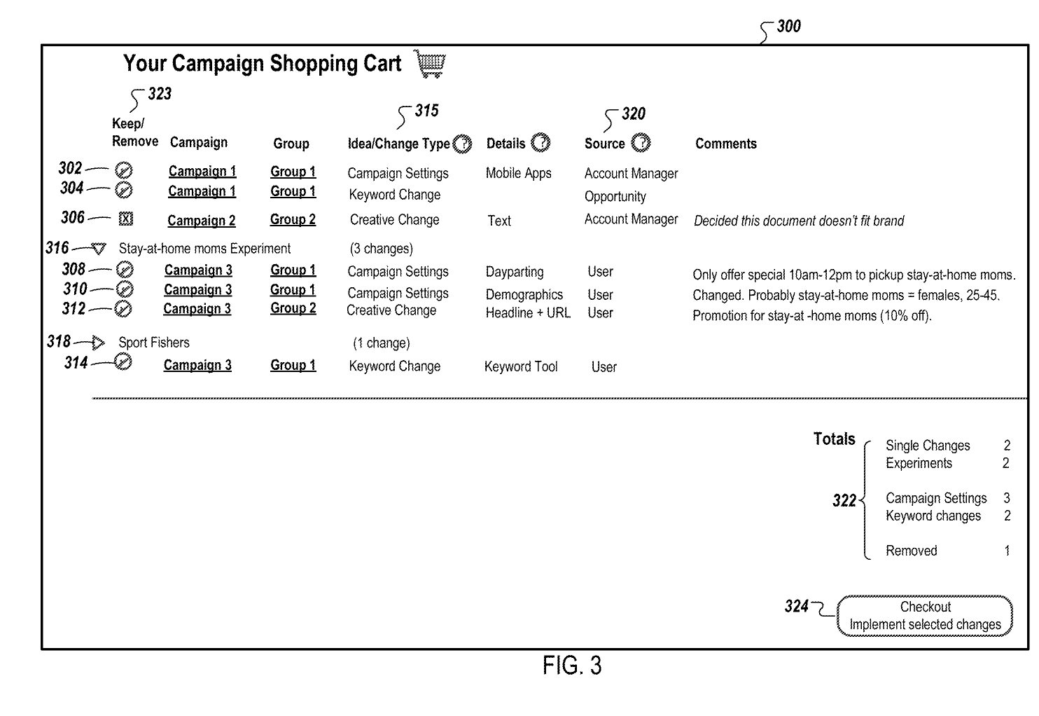

FIG. 3 illustrates an example user interface 300. In the example shown, user interface 300 is presented as a shopping cart. Other types of user interfaces can be used. The user interface 300 can be used, for example, by a content sponsor to view and manage drafts and experiments. The user interface 300 includes row 302-314 which each correspond to a proposed modification to a campaign of the content sponsor. Rows 302, 308, and 310 each correspond to a respective campaign setting change (e.g., as indicated by respective entries in a column 315). For example, row 302 corresponds to the changing of selection criteria to include content requests from mobile applications. Row 308 corresponds to the changing of selection criteria to include the matching of a particular time of day. Row 310 corresponds to the changing of demographic selection criteria to include female users aged 25-45. Rows 304 and 314 each correspond to a change of a keyword. Rows 306 and 312 each correspond to the changing of content (e.g., text, heading, URL (Uniform Resource Locator) of a content item included in a campaign of the content sponsor.

The changes corresponding to rows 308, 310, and 312 are grouped under an experiment row 316. For example, the changes corresponding to rows 308, 310, and 312 can be included in an experiment related to stay-at-home mothers. The change corresponding to row 314 can be included in an experiment related to sport fishing that is associated with an experiment row 318.

The changes corresponding to rows 308, 310, 312, and 314 have been provided by the content sponsor (e.g., as indicated by respective entries in a source column 320). For example, the content sponsor can provide the changes using a draft editor. The changes corresponding to rows 302 and 306 have been provided to the content sponsor as suggestions from, for example, an account manager associated with a content management system which manages the content campaigns of the content sponsor. The change corresponding to row 304 has been provided by an automated opportunity system which automatically identifies opportunities for the content sponsor and presents such opportunities as suggested changes.

A summary area 322 includes a summary of the changes included in the rows 302-314. The content sponsor can use controls included in a column 323 to specify whether respective changes are to be kept (e.g., accepted) or removed (e.g., rejected) by the content sponsor. For example, the change corresponding to row 306 has been removed and the changes corresponding to rows 302-304 and 308-314 have been accepted. A control 324 can be selected to implement the accepted (e.g., selected) changes. Subsequent to selection of the control 324, the content sponsor can be presented with other user interfaces from which the content sponsor can provide further details, e.g., for running an experiment and/or for specifying whether an accepted change is to be incorporated into a respective campaign or whether an accepted change is to be implemented as one or more parameters in a newly-created campaign.

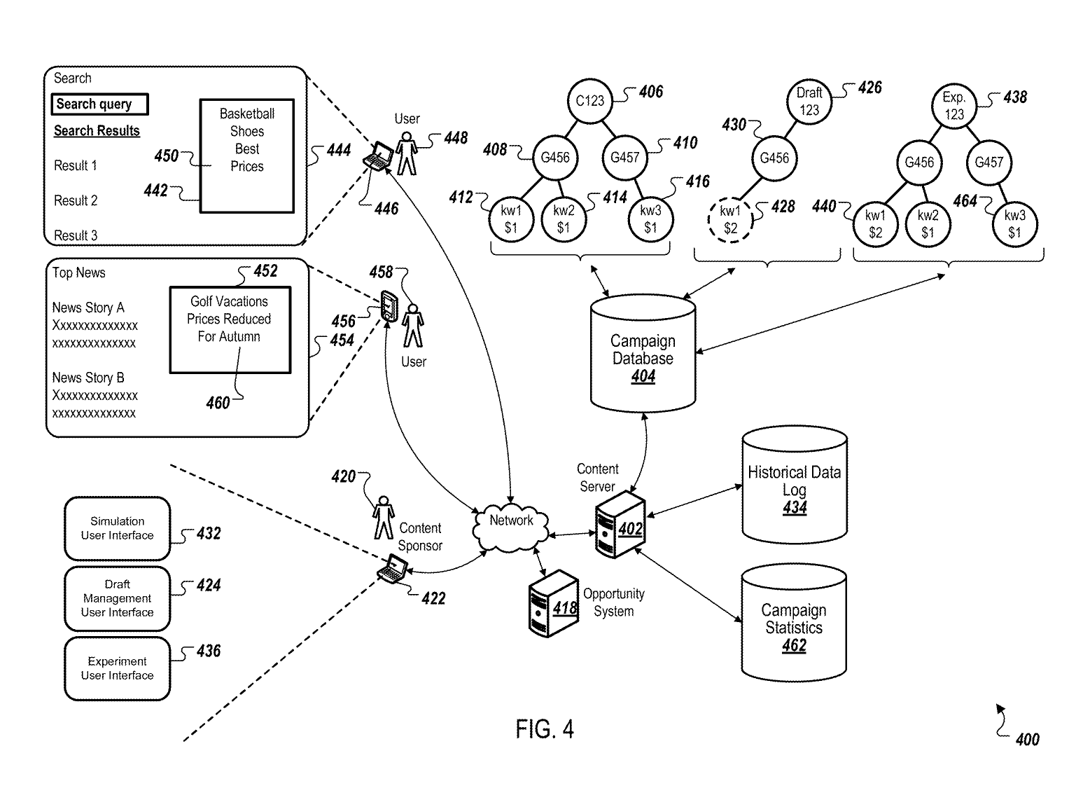

FIG. 4 is a block diagram of an example system 400 for conducting an experiment for a campaign. A content server 402 manages a campaign database 404. For example, the campaign database 404 includes a campaign data structure 406 for a campaign “123”. The campaign data structure 406 includes information for a first content group “456” 408 and a second content group “457” 410. The first content group 408 and the second content group 410 can each include a set of content items (not shown).

The first content group 408 and the second content group 410 each include selection criteria. The selection criteria define conditions that are to be satisfied for an individual content item of a respective group to be eligible to be presented responsive to a received request. For example, the first content group 408 includes first selection criteria 412 and second selection criteria 414. The first selection criteria 412 includes a first keyword (e.g., “kw1”) and a corresponding bid for the first keyword and the second selection criteria 414 includes a second keyword (e.g., “kw2”) and a corresponding bid for the second keyword. Similarly, the second content group 410 includes third selection criteria 416 that include a third keyword (e.g., “kw3”) and a corresponding bid for the third keyword.

The content server 402 can receive an indication of a proposed modification to be made to the campaign associated with the campaign data structure 406. For example, the proposed modification can be a change to one or more campaign parameters or to the first selection criteria 412, the second selection criteria 414, or the third selection criteria 416. The proposed modification can be automatically received, for example, from an opportunity system 418 which automatically identifies potential modifications that may be beneficial to a content sponsor 420 associated with the campaign.

As another example, the proposed modification can be received from a content sponsor device 422 of the content sponsor 420. For example, the content sponsor 420 can use a draft editor included in a draft management user interface 424 to define a draft campaign which includes the proposed modification. The content sponsor 420 can perform other operations relating to draft campaigns using the draft management user interface 424. For example, the content sponsor 420 can view a list of draft campaigns, name or rename a draft campaign, add comments to a draft campaign (e.g., to describe an idea and/or goal for the draft campaign), delete a draft campaign, make a copy of a draft campaign, create an experiment based on a draft campaign (described in more detail below), or implement a draft campaign (described in more detail below). Other operations are possible.

The content server 402 can store a draft data structure 426 for the draft campaign in the campaign database 404. The draft data structure 426 can be stored in association with a same schema that is used for the campaign data structure 406. The schema can define, for example, a data structure format that can store a campaign identifier, one or more content groups that are associated with the campaign, one or more creatives that are associated with each content group, and selection criteria and other parameters that can be associated, for example, with a creative or with a content group. In some implementations, the schema can define fields or data items that are specific to draft campaigns. For example, the schema can define a field which can be used to link a draft campaign to a base campaign. For example, the draft data structure 426 can reference the campaign data structure 406. Although the draft data structure 426 is stored in the campaign database 404, the draft data structure 406 can include a setting which results in the content server 402 not selecting the draft campaign in response to requests for content. For example, the schema can define a flag field which if set can indicate that the campaign is not to be used for servicing requests for content.

The campaign associated with the campaign data structure 406 can be referred to as an original (e.g., base) campaign. The draft data structure 426 can be referred to as a shadow data structure. In some implementations, the draft data structure 426 includes only the differences that are proposed to the original campaign and other data items that may be necessary for providing context and/or building an appropriate hierarchy of data elements. For example, the draft data structure 426 includes modified selection criteria 428 (e.g., the modified selection criteria 428 include a modified bid (e.g., $2) for the first keyword). As another example, the draft data structure 426 includes a content group 430 corresponding to the first content group 408, to provide context for the modified selection criteria 428. The content group 430 can be added to provide the context even if the received proposed modification does not reference the content group 430.

The content sponsor 420 can use a simulation user interface 432 to initiate a simulation using the draft campaign. The simulation can include re-running auctions using a historical data log of transactions 434 with the draft campaign included in the auctions as a campaign that is eligible to be an auction winner. The simulation can be used to predict a success rate for implementing the changes represented by the draft campaign. In some implementations, a simulation uses an experiment campaign and an experiment data structure rather than the draft campaign and the draft data structure 426. Experiment campaigns and experiment data structures are discussed in more detail below.

To determine a more accurate estimation of the effects of implementing the draft campaign, an experiment can be performed. For example, when the proposed modification(s) associated with the draft campaign are received from the opportunity system 418, an experiment can be automatically conducted. As another example, the content sponsor 420 can define and initiate an experiment using an experiment user interface 436.

For example, the content sponsor 420 can specify a traffic split percentage which indicates a traffic split between an experiment campaign and the original campaign. For example, during the experiment, a certain portion of traffic that would have gone to the original campaign can go to the experiment campaign. That is, the experiment campaign can participate, in place of the original campaign, in a certain percentage of auctions conducted in response to received requests for content. The original campaign can be referred to as a control arm of the experiment and the experiment campaign can be referred to as an experiment arm. The split can be percentage of traffic, or can define a particular portion of traffic that is to use the experiment campaign when evaluating received requests for content (e.g., a strict amount representing X % or a portion defined by time, requesting source, environment, or other conditions).

The content sponsor 420 can use the experiment user interface 436 to specify a start date/time and a stop date/time for the experiment, rename, add comments to, or otherwise edit an experiment, delete an experiment, or start, stop or pause an experiment. If an experiment is paused or stopped, the experiment campaign is no longer entered into auctions and the original campaign receives 100% of the traffic. The content sponsor 420 can view statistics related to the experiment and/or the original campaign. Experiment statistics are discussed in more detail below.

The content server 402 can store an experiment data structure 438 for the experiment in the campaign database 404. The experiment data structure 438 can be stored in association with a same schema that is used for the campaign data structure 406. The experiment data structure 438 represents the original campaign with the proposed modification applied. For example, the experiment data structure 438 has the same structure as the campaign data structure 406 except for a modified first selection criteria 440 which includes the proposed bid change. The campaign represented by the experiment data structure 438 can be referred to as an experiment campaign. Creating the experiment data structure 438 from the campaign data structure 406 and the draft data structure 426 can be referred to as materializing the experiment campaign. As discussed in more detail below, the content server 402 can synchronize changes to the campaign data structure 406 or the draft data structure 426 with the experiment data structure 438.

As an example of activity during an experiment, a content item included in the experiment campaign can participate in an auction for a content slot 442 included in a user interface 444 presented on a user device 446 of a user 448, using the modified selection criteria 440. The content item can win the auction and can be provided to the user device 446 for presentation in the content slot 442, as illustrated by a content item 450.

As another example, a content item included in the original campaign can participate in an auction for a content slot 452 included in a user interface 454 presented on a user device 456 of a user 458, using the first selection criteria 412. Due, for example, to a lower bid associated with the first selection criteria 412 as compared to a higher bid associated with the modified first selection criteria 440, a content item other than the content item included in the original campaign can win the auction, as illustrated by a content item 460.

The content server 402 can store campaign statistics for both the original campaign and the experiment campaign, such as in a campaign statistics database 462. For example, statistics related to impressions of content items, interactions (e.g., selections, conversions) with content items, click through rate, and cost can be stored for both the original campaign and the experiment campaign. The content sponsor 420 can view statistics for the experiment campaign, the original campaign, and/or comparison statistics comparing the experiment campaign to the original campaign, using the experiment user interface 436.

Based on viewing experiment and/or simulation results, the content sponsor 420 can decide whether to implement the draft campaign (e.g., move the draft campaign to production). For example, a new campaign separate from the original campaign can be created that includes the proposed modification(s). Such a creation can be referred to as promoting the draft campaign as a new campaign. As another example, the proposed modifications can be incorporated into the original campaign. In some implementations, if an experiment associated with the draft campaign is running when the draft campaign is implemented, the experiment is halted.

The content server 402 can synchronize changes made to the original campaign and/or to the draft campaign. That is, when a user makes a change to an existing campaign, the change can be reflected not only in the existing campaign but also in any experiments that are currently active that are related to the existing campaign. For example, the content server 402 can propagate changes made to the original campaign to the draft campaign. As a specific example, if a change is made to a bid for the third keyword included in the third selection criteria 416, that change can be propagated to modified third selection criteria 464.

If a change to the original campaign relates to an existing change included in the draft campaign, then the change to the original campaign may not be propagated to the draft campaign. For example, if the bid associated with the first keyword in the first selection criteria 412 is changed, that change may not be propagated to the draft campaign when the draft campaign already includes a proposed modification to the bid for the first keyword. However, if a URL associated with the first selection criteria 412 is changed, such a change can be propagated to the modified selection criteria 428 and the modified first selection criteria 440.

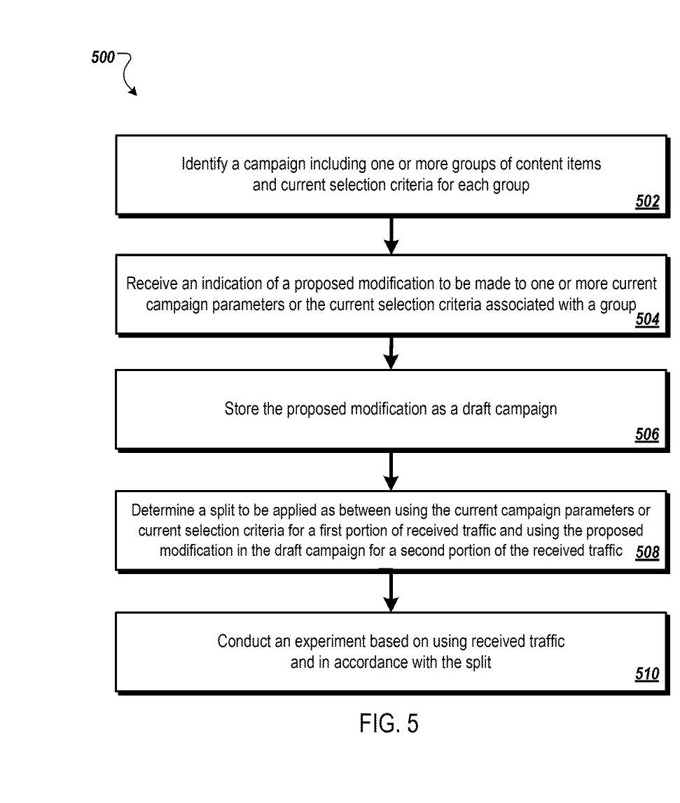

FIG. 5 is a flowchart of an example process 500 for conducting an experiment for a campaign. The process 500 can be performed, for example, by the content management system 110 described above with respect to FIG. 1.

A campaign is identified (502), the campaign including one or more groups of content items and current selection criteria for each group, wherein the current selection criteria define conditions that are to be satisfied for an individual content item to be eligible to be presented responsive to a received request. In some implementations, two or more campaigns can be identified.

An indication of a proposed modification is received (504), the proposed modification to be made to one or more current campaign parameters or the current selection criteria associated with a group. The proposed modification can be received, for example, from a campaign sponsor associated with the campaign, such as from a user interface. As another example, the proposed modification can be received from an account manager user associated with a content management system that managers the content campaign. In some implementations, the proposed modification is received from an automated system which automatically identifies the proposed modification as a suggestion for the campaign sponsor. The suggestion and other types of proposed modifications can be received through invocation of an API (Application Programming Interface). The proposed modification can be at a campaign level and can include modifications of one or more of geographic selection parameters, bidding parameters, extensions, or scheduling parameters. Other examples of proposed modifications include the addition or removal of selection criteria (e.g., keywords), the changing of bids, or the changing of content of a content item. When two or more campaigns are identified, two or more proposed modifications can be received, with each proposed modification being associated with a respective campaign. As another example, the proposed modification can be a modification to be applied across multiple campaigns.

The proposed modification is stored as a draft campaign (506), including storing the proposed modification in a first structure that includes only the differences that are proposed to the campaign and a second structure that represents the campaign with the proposed modifications applied. The first structure and the second structure can be stored, for example, in a same database or repository in which the identified campaign is stored. The database or repository can support hierarchical data. For example, the first structure and the second structure can store information about campaigns, content groups included in a respective campaign, and content items included in a respective content group. When multiple proposed modifications are received for multiple campaigns, the multiple proposed modifications can be stored as multiple draft campaigns.

A split to be applied is determined (508), the split as between using the current campaign parameters or current selection criteria for a first portion of received traffic and using the proposed modification in the draft campaign for a second portion of the received traffic. The split can be at a geographic, device, or user or device identifier (e.g., cookie) level. The split can be defined using one or more parameters. For example, a demographic classification can be used to assist in defining the split (e.g., gender can be used to define two different campaigns (the original and the draft). Similarly, other demographic characteristics can be used to divide the received impressions into respective portions of the current campaign or draft campaign. In another example, device type can be used to define a split (e.g., mobile devices receive the current campaign, while non-mobile devices are associated with the draft campaign). In another example, the presence or absence of a particular cookie can be used to define a split. In still another example, other parameters can be used to define a split.

The split can be automatically determined or can be received, e.g., from a user or another system. In some implementations, the split is predetermined (e.g., 20% to the proposed modification, 80% to the current selection criteria). In some implementations, the split is determined based on a determined number of impressions to provide using the current campaign parameters or current selection criteria and on an estimated number of available impressions. For example, a content sponsor may desire or may have been promised a particular number of impressions in a time period using the current campaign parameters and current selection criteria (e.g., during execution of the campaign). Such impressions can be referred to as expected impressions. When, for example, the estimated number of available impressions is more than a threshold amount greater than the number of expected impressions, a higher percentage of impressions can be allocated to the proposed modification than when the estimated number of available impressions is not more than the threshold amount greater than the number of expected impressions. When multiple campaigns are identified, multiple splits can be determined.

An experiment is conducted based on using received traffic and in accordance with the split (510), including delivering impressions based on both the current campaign parameters or current selection criteria and the proposed modification including serving content in accordance with the campaign and the draft campaign. In some implementations, subsequent requests associated with a particular user after a first request for the user are processed using the same campaign (e.g., either the draft campaign or the original campaign) as used for the first request for the user. Conducting the experiment can include measuring statistical significance of the proposed modification and reporting the same to a campaign sponsor. For example, a determination can be made that the experiment has run long enough to be statistically significant. For example, a determination can be made that an experiment is statistically significant when more than a first threshold number of impressions are delivered based on the current campaign parameters or current selection criteria and more than a second threshold number of impressions are delivered based on the proposed modification.

An indication to adopt the proposed modification can be received and the campaign can be converted based on the draft campaign. For example, the draft campaign can be recalled, the experiment can be halted, and one or more selection criteria or other parameters associated with the campaign can be updated based on the proposed modifications associated with the draft campaign. In some implementations, an indication can be received to adopt some but not all of the changes represented by the proposed modification. For example, an indication can be received to adopt a first change to a first campaign parameter but to not adopt a second change to a second campaign parameter.

In some implementations, multiple experiments can be conducted. For example, a draft campaign can be created for each experiment and each experiment can be conducted using a respective draft campaign. The draft campaigns can be run simultaneously or sequentially. When two or more draft campaigns are run simultaneously, a split can be determined between the original campaign and the draft campaigns. For example, 70% of traffic can be sent to the original campaign, 20% to a first draft campaign, and 10% to a second draft campaign. When two or more of the draft campaigns are run sequentially, a split can be determined between the original campaign and a respective draft campaign associated with a current experiment. Experiment results of the multiple experiments can be reported to the campaign sponsor in an interface. Based on user input or on a determination made by an automated process, one or more of the draft campaigns can be converted based on results of a respective experiment. Converting a draft campaign can include creating a new campaign based on the draft campaign or incorporating the draft campaign into the identified campaign.

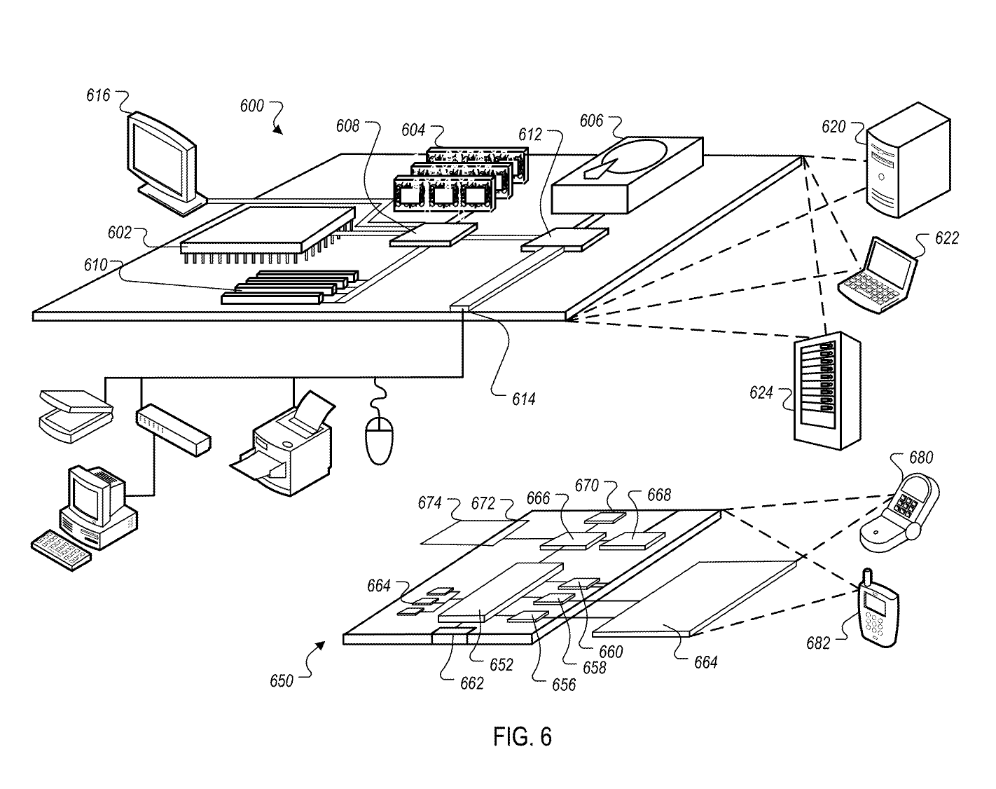

FIG. 6 is a block diagram of computing devices 600, 650 that may be used to implement the systems and methods described in this document, as either a client or as a server or plurality of servers. Computing device 600 is intended to represent various forms of digital computers, such as laptops, desktops, workstations, personal digital assistants, servers, blade servers, mainframes, and other appropriate computers. Computing device 650 is intended to represent various forms of mobile devices, such as personal digital assistants, cellular telephones, smartphones, and other similar computing devices. The components shown here, their connections and relationships, and their functions, are meant to be illustrative only, and are not meant to limit implementations of the inventions described and/or claimed in this document.

Computing device 600 includes a processor 602, memory 604, a storage device 606, a high-speed interface 608 connecting to memory 604 and high-speed expansion ports 610, and a low speed interface 612 connecting to low speed bus 614 and storage device 606. Each of the components 602, 604, 606, 608, 610, and 612, are interconnected using various busses, and may be mounted on a common motherboard or in other manners as appropriate. The processor 602 can process instructions for execution within the computing device 600, including instructions stored in the memory 604 or on the storage device 606 to display graphical information for a GUI on an external input/output device, such as display 616 coupled to high speed interface 608. In other implementations, multiple processors and/or multiple buses may be used, as appropriate, along with multiple memories and types of memory. Also, multiple computing devices 600 may be connected, with each device providing portions of the necessary operations (e.g., as a server bank, a group of blade servers, or a multi-processor system).

The memory 604 stores information within the computing device 600. In one implementation, the memory 604 is a computer-readable medium. The computer-readable medium is not a propagating signal. In one implementation, the memory 604 is a volatile memory unit or units. In another implementation, the memory 604 is a non-volatile memory unit or units.

The storage device 606 is capable of providing mass storage for the computing device 600. In one implementation, the storage device 606 is a computer-readable medium. In various different implementations, the storage device 606 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 604, the storage device 606, or memory on processor 602.

The high speed controller 608 manages bandwidth-intensive operations for the computing device 600, while the low speed controller 612 manages lower bandwidth-intensive operations. Such allocation of duties is illustrative only. In one implementation, the high-speed controller 608 is coupled to memory 604, display 616 (e.g., through a graphics processor or accelerator), and to high-speed expansion ports 610, which may accept various expansion cards (not shown). In the implementation, low-speed controller 612 is coupled to storage device 606 and low-speed expansion port 614. The low-speed expansion port, which may include various communication ports (e.g., USB, Bluetooth®, Ethernet, wireless Ethernet) may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 620, or multiple times in a group of such servers. It may also be implemented as part of a rack server system 624. In addition, it may be implemented in a personal computer such as a laptop computer 622. Alternatively, components from computing device 600 may be combined with other components in a mobile device (not shown), such as device 650. Each of such devices may contain one or more of computing device 600, 650, and an entire system may be made up of multiple computing devices 600, 650 communicating with each other.

Computing device 650 includes a processor 652, memory 664, an input/output device such as a display 654, a communication interface 666, and a transceiver 668, among other components. The device 650 may also be provided with a storage device, such as a microdrive or other device, to provide additional storage. Each of the components 650, 652, 664, 654, 666, and 668, are interconnected using various buses, and several of the components may be mounted on a common motherboard or in other manners as appropriate.

The processor 652 can process instructions for execution within the computing device 650, including instructions stored in the memory 664. The processor may also include separate analog and digital processors. The processor may provide, for example, for coordination of the other components of the device 650, such as control of user interfaces, applications run by device 650, and wireless communication by device 650.

Processor 652 may communicate with a user through control interface 658 and display interface 656 coupled to a display 654. The display 654 may be, for example, a TFT LCD display or an OLED display, or other appropriate display technology. The display interface 656 may comprise appropriate circuitry for driving the display 654 to present graphical and other information to a user. The control interface 658 may receive commands from a user and convert them for submission to the processor 652. In addition, an external interface 662 may be provide in communication with processor 652, so as to enable near area communication of device 650 with other devices. External interface 662 may provide, for example, for wired communication (e.g., via a docking procedure) or for wireless communication (e.g., via Bluetooth or other such technologies).

The memory 664 stores information within the computing device 650. In one implementation, the memory 664 is a computer-readable medium. In one implementation, the memory 664 is a volatile memory unit or units. In another implementation, the memory 664 is a non-volatile memory unit or units. Expansion memory 674 may also be provided and connected to device 650 through expansion interface 672, which may include, for example, a SIMM card interface. Such expansion memory 674 may provide extra storage space for device 650, or may also store applications or other information for device 650. Specifically, expansion memory 674 may include instructions to carry out or supplement the processes described above, and may include secure information also. Thus, for example, expansion memory 674 may be provide as a security module for device 650, and may be programmed with instructions that permit secure use of device 650. In addition, secure applications may be provided via the SIMM cards, along with additional information, such as placing identifying information on the SIMM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 664, expansion memory 674, or memory on processor 652.

Device 650 may communicate wirelessly through communication interface 666, which may include digital signal processing circuitry where necessary. Communication interface 666 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 668. In addition, short-range communication may occur, such as using a Bluetooth, WiFi, or other such transceiver (not shown). In addition, GPS receiver module 670 may provide additional wireless data to device 650, which may be used as appropriate by applications running on device 650.

Device 650 may also communicate audibly using audio codec 660, which may receive spoken information from a user and convert it to usable digital information. Audio codex 660 may likewise generate audible sound for a user, such as through a speaker, e.g., in a handset of device 650. Such sound may include sound from voice telephone calls, may include recorded sound (e.g., voice messages, music files, etc.) and may also include sound generated by applications operating on device 650.

The computing device 650 may be implemented in a number of different forms, as shown in the figure. For example, it may be implemented as a cellular telephone 680. It may also be implemented as part of a smartphone 682, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back-end component (e.g., as a data server), or that includes a middleware component (e.g., an application server), or that includes a front-end component (e.g., a client computer having a graphical user interface or a Web browser through which a user can interact with an implementation of the systems and techniques described here), or any combination of such back-end, middleware, or front-end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. For example, various forms of the flows shown above may be used, with steps re-ordered, added, or removed. Also, although several applications of the payment systems and methods have been described, it should be recognized that numerous other applications are contemplated. Accordingly, other embodiments are within the scope of the following claims.

What is claimed is:

1. A method comprising:
identifying a campaign, the campaign including one or more groups of content items and current selection criteria for each group, wherein the current selection criteria define conditions that are to be satisfied for an individual content item to be eligible to be presented responsive to a received request;
receiving an indication of a proposed modification to be made to one or more current campaign parameters or the current selection criteria associated with a group;
storing the proposed modification as a draft campaign including storing the proposed modification in a first structure that includes only the differences that are proposed to the campaign and a second structure that represents the campaign with the proposed modifications applied;
determining a split to be applied as between using the current campaign parameters or current selection criteria for a first portion of received traffic and using the proposed modification in the draft campaign for a second portion of the received traffic; and
conducting an experiment based on using received traffic and in accordance with the split including delivering impressions based on both the current campaign parameters or current selection criteria and the proposed modification including serving content in accordance with the campaign and the draft campaign.

2. The method of claim 1 wherein receiving an indication of a proposed modification includes receiving an indication of a group for inclusion in an experiment including identifying a current set of selection criteria associated with the group and receiving an indication of a proposed modification to be made to the current set of selection criteria associated with the group.

3. The method of claim 1 wherein the split is at a geographic, device or cookie level.

4. The method of claim 1 wherein the proposed modification is at a campaign level including modifications of one or more of geographic selection parameters, bidding parameters, extensions, or scheduling parameters.

5. The method of claim 1 further comprising providing a user interface that includes a list of experiments, predictions and results.

6. The method of claim 1 wherein the campaign is a first campaign, and the method further includes synching the first campaign with a different second campaign based on results of the experiment including applying the proposed modifications to the second different campaign.

7. The method of claim 1 wherein conducting the experiment includes measuring statistical significance of the proposed modification and providing a report of the same to a campaign sponsor.

8. The method of claim 1 further comprising identifying when the experiment has run long enough to be statistically significant and alerting a campaign sponsor.

9. The method of claim 1 further comprising automatically selecting potential proposed modifications for the campaign without interaction of a campaign sponsor, conducting automatic experiments and providing suggestions to the campaign sponsor based on the automatic experiments.

10. The method of claim 1 further comprising receiving an indication to adopt the proposed modification and converting the campaign based on the draft campaign including recalling the draft campaign and updating one or more selection criteria associated with the campaign based on the draft campaign.

11. The method of claim 1 further comprising conducting multiple experiments including creating a draft campaign for each experiment, reporting experiment results and converting one or more of the draft campaigns based on results of a respective experiment.

12. The method of claim 1 further comprising re-running an experiment using a historical data log of transactions to simulate results of the experiment as against previous traffic and using results to predict a success rate for the experiment.

13. The method of claim 10 wherein the proposed modification indicates a first change to a first campaign parameter and a second change to a second campaign parameter and wherein receiving the indication to adopt the proposed modification comprises receiving an indication to adopt the first change but not the second change.

14. The method of claim 1 further comprising:
receiving, after storing the draft campaign, a modification to the campaign modifying different campaign parameters or selection criteria than the proposed modification;
applying the modification to the campaign; and
applying the modification to the draft campaign.

15. A system comprising:
one or more processors; and
one or more memory elements including instructions that when executed cause the one or more processors to:
identify a campaign, the campaign including one or more groups of content items and current selection criteria for each group, wherein the current selection criteria define conditions that are to be satisfied for an individual content item to be eligible to be presented responsive to a received request;
receive an indication of a proposed modification to be made to one or more current campaign parameters or the current selection criteria associated with a group;
store the proposed modification as a draft campaign including storing the proposed modification in a first structure that includes only the differences that are proposed to the campaign and a second structure that represents the campaign with the proposed modifications applied;
determine a split to be applied as between using the current campaign parameters or current selection criteria for a first portion of received traffic and using the proposed modification in the draft campaign for a second portion of the received traffic; and
conduct an experiment based on using received traffic and in accordance with the split including delivering impressions based on both the current campaign parameters or current selection criteria and the proposed modification including serving content in accordance with the campaign and the draft campaign.

16. The system of claim 15 wherein the split is at a geographic, device or cookie level.

17. The system of claim 15 wherein the proposed modification is at a campaign level including modifications of one or more of geographic selection parameters, bidding parameters, extensions, or scheduling parameters.

18. A computer program product tangibly embodied in a computer-readable storage device and comprising instructions that, when executed by a processor, cause the processor to:
identify a campaign, the campaign including one or more groups of content items and current selection criteria for each group, wherein the current selection criteria define conditions that are to be satisfied for an individual content item to be eligible to be presented responsive to a received request;
receive an indication of a proposed modification to be made to one or more current campaign parameters or the current selection criteria associated with a group;
store the proposed modification as a draft campaign including storing the proposed modification in a first structure that includes only the differences that are proposed to the campaign and a second structure that represents the campaign with the proposed modifications applied;
determine a split to be applied as between using the current campaign parameters or current selection criteria for a first portion of received traffic and using the proposed modification in the draft campaign for a second portion of the received traffic; and
conduct an experiment based on using received traffic and in accordance with the split including delivering impressions based on both the current campaign parameters or current selection criteria and the proposed modification including serving content in accordance with the campaign and the draft campaign.

19. The product of claim 18 wherein the split is at a geographic, device or cookie level.

20. The product of claim 18 wherein the proposed modification is at a campaign level including modifications of one or more of geographic selection parameters, bidding parameters, extensions, or scheduling parameters.
